(19) United States
(12) Patent Application Publication
(10) Pub. No.: US 2026/0310992 A1
(43) Pub. Date: Oct. 8, 2026

(54) DETERMINING PATTERNS OF EVENT ACTIVITY FOR PREDICTING LOCATION ACTIVITIES AND FOR DETECTING OUT-OF-PATTERN EVENTS

(71) Applicant: KHYROS LLC, McLean, VA (US)

(72) Inventor: Shea Ryan HARTLEY, Alexandria, VA (US)

(73) Assignee: KHYROS LLC, McLean, VA (US)

(21) Appl. No.: 19/542,253

(22) Filed: Feb. 17, 2026

Related U.S. Application Data
(60) Provisional application No. 63/759,058, filed on Feb. 15, 2025.

(51) Int. Cl. G06N 5/022

(52) U.S. Cl. CPC G06N 5/022

(57) ABSTRACT

A system and method configured to receive geospatial data including latitude, longitude and timestamps for a plurality of events associated with at least one entity, create a pivot table of unique events per date and hour from the received geospatial data, use a location classification model on outputs of the pivot table to identify likely activities for the events that have been detected at different locations associated with the at least one entity based upon operations of the location classification model, and provide a display output on a user interface displaying patterns of the events associated with the at least one entity. The system and method are also configured to detect out-of-pattern events for an entity providing the geospatial data.

### TECHNICAL FIELD

The present disclosure is related generally to systems and methods for determining patterns of event activity for an entity, using a location classification model to identify locations of events from geospatial data and for predicting the activities taking place at the identified locations. In addition, the present disclosure relates to systems and methods for determining co-locations of events between different entities and for detecting out-of-pattern events from received geospatial data.

### BACKGROUND

Geospatial analysis has become increasingly used by a wide range of organizations for collecting, analyzing and visualizing data with geographic or spatial components to gain insights into patterns, trends, and relationships related to locations of a user or an entity being tracked by a user. Such analysis has proven to be valuable for understanding how people, objects or phenomena interact within space, and can be used to make predictions based on patterns determined by the analysis. However, previous techniques have been cumbersome in terms of quickly determining patterns and providing meaningful, easy to understand displays for human users showing patterns for the monitored events. Furthermore, previous techniques have not provided clear displays of co-location/co-time events of multiple entities. Previous techniques have also failed to provide accurate and easily understandable displays of out-of-pattern events from the received geospatial data.

### SUMMARY

An example system is disclosed including one or more processors and a machine-readable media storing instructions. The instructions cause the processor to receive geospatial data including latitude, longitude and timestamps for a plurality of events associated with a first entity and a second entity, wherein the geospatial data has been enriched with at least one of geohashes and temporal hashes, create a pivot table of unique events per date and hour from the received geospatial data for the first entity and the second entity, and use a location classification model on outputs of the pivot table to identify likely activities of the first entity and the second entity for the events that have been detected at different locations associated with the first entity and the second entity based upon operations of the location classification model, and provide a display output on a user interface displaying one or more patterns of the events associated with the first entity and the second entity and the likely activities for the displayed one or more patterns. The display output is a clock chart displaying the likely activities in a color-coded manner for each day of a week such that the color-coding indicates an activity count for the likely activity for each hour of each day of the week and the location classification model is trained by a convolutional neural network (CNN) having at least five convolutional layers.

An example method is also disclosed, including receiving geospatial data including latitude, longitude and timestamps for a plurality of events associated with a first entity and a second entity, wherein the geospatial data has been enriched with at least one of geohashes and temporal hashes, creating a pivot table of unique events per date and hour from the received geospatial data for the first entity and the second entity, using a location classification model on outputs of the pivot table to identify likely activities of the first entity and the second entity for the events that have been detected at different locations associated with the first entity and the second entity based upon operations of the location classification model, and providing a display output on a user interface displaying one or more patterns of the events associated with the first entity and the second entity and the likely activities for the displayed one or more patterns. The display output is a clock chart displaying the likely activities in a color-coded manner for each day of a week such that the color-coding indicates an activity count for the likely activity for each hour of each day of the week, and the location classification model is trained by a convolutional neural network (CNN) having at least five convolutional layers.

An example computer-readable medium is also disclosed for determining and displaying co-location events for different entities on a map displayed on a display device. To achieve this, the computer-readable medium has instructions stored thereon that, when executed by a processing system, perform a method including receiving geospatial data including latitude, longitude and timestamps for a plurality of events associated with a first entity and a second entity, wherein the geospatial data has been enriched with at least one of geohashes and temporal hashes, creating a pivot table of unique events per date and hour from the received geospatial data for the first entity and the second entity, using a location classification model on outputs of the pivot table to identify likely activities of the first entity and the second entity for the events that have been detected at different locations associated with the first entity and the second entity based upon operations of the location classification model, and providing a display output on a user interface displaying one or more patterns of the events associated with the first entity and the second entity and the likely activities for the displayed one or more patterns. The display output is a clock chart displaying the likely activities in a color-coded manner for each day of a week such that the color-coding indicates an activity count for the likely activity for each hour of each day of the week, and the location classification model is trained by a convolutional neural network (CNN) having at least five convolutional layers.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 shows an example system upon which aspects of this disclosure may be implemented, in accordance with aspects of the disclosure.

FIG. 2 is a flow diagram showing steps for data preparation, in accordance with aspects of the disclosure.

FIG. 3A is a flow diagram showing an activity patterns workflow, in accordance with aspects of the disclosure.

FIG. 3B is a clock chart derived from the activity patterns workflow of FIG. 3A.

FIG. 4 is a flow diagram showing a first basic implementation of training technology of the location classification model, in accordance with aspects of the disclosure.

FIG. 5 is a flow diagram showing an alternative upgraded implementation of training technology of the location classification model, in accordance with aspects of the disclosure.

FIG. 6 is a flow diagram showing steps for co-location event detection, in accordance with aspects of the disclosure.

FIG. 7A shows a flow diagram of steps for out-of-pattern event detection, in accordance with aspects of the disclosure.

FIG. 7B shows a user interface for out-of-pattern event detection derived from the steps shown in FIG. 7A.

FIGS. 8A-8C show user interface displays for activity pattern classification, in accordance with aspects of the disclosure.

FIG. 9 shows a user interface display for co-location event detection, in accordance with aspects of the disclosure.

FIG. 10 shows a user interface display for out-of-pattern event detection, in accordance with aspects of the disclosure.

FIG. 11 shows a feature roadmap of advantageous features being developed based on the system and method disclosed in the present disclosure.

FIG. 12 is a block diagram illustrating an example software architecture, various portions of which may be used in conjunction with various hardware architectures herein described in accordance with aspects of the disclosure.

FIG. 13 is a block diagram illustrating components of an example machine configured to read instructions from a machine-readable medium and perform any of the features described herein in accordance with aspects of the disclosure.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

The present disclosure provides a technical solution to the above noted technical problems regarding providing easy to understand displays of patterns in geospatial data of events of monitored entities, particularly regarding displaying co-location/co-time events between different entities and for displaying out-of-pattern events.

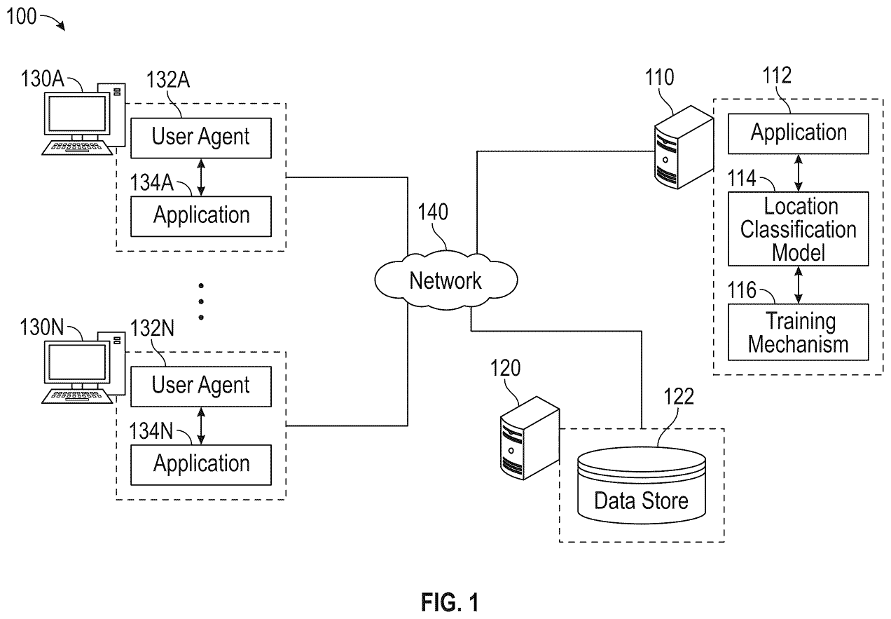

FIG. 1 shows an example system upon which aspects of this disclosure may be implemented, in accordance with aspects of the disclosure. Specifically, FIG. 1 illustrates an example system 100, upon which aspects of this disclosure may be implemented. The system 100 may include a server 110, which may itself include an application 112, a location classification model 114 and a training mechanism 116. While shown as one server, the server 110 may represent a plurality of servers that work together to deliver the functions and services provided by each engine or application included in the server 110. The server 110 may operate as a shared resource server located at an enterprise accessible by various computer client devices such as client devices 130A-130N. The server 110 may also operate as a cloud-based server for determination of patterns in geospatial data and making predictions about locations where events occur from the determined patterns for one or more applications such as application 112 in the server 110 and/or applications 134A-134N in the client devices 130A-134N.

The server 110 may include and/or execute a geospatial analysis of geospatial data provided to a location classification model 114 in the server 110, which may monitor geospatial data collected from users' use of an application such as the applications 134A-134N to obtain the geospatial data either for the users or for other entities being monitored by the user. For example, the client devices 130A-130N can be smartphones, which provide periodic location data (e.g., latitude and longitude) of the location of the client devices, together with timestamps, to the server 110. Alternatively, the geospatial data can be data gathered by the client devices 130A-130N by sensing devices used to monitor an external entity, including radar, sonar, lidar, motion detectors, heat sensors, pressure sensors, etc.

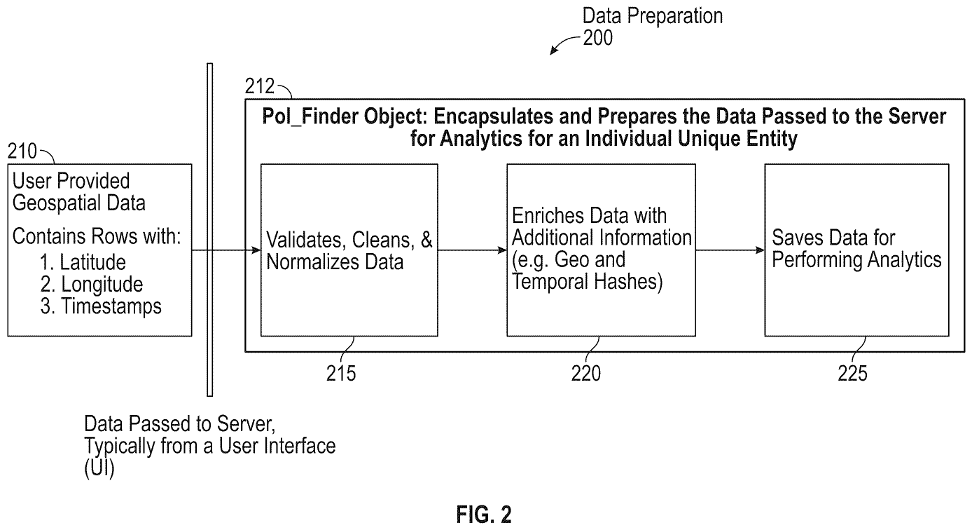

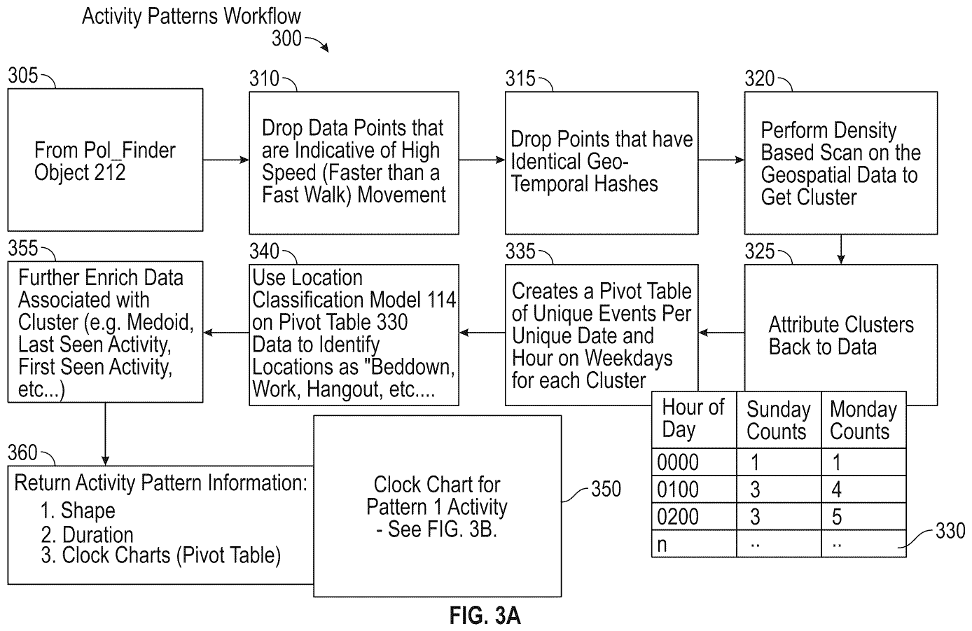

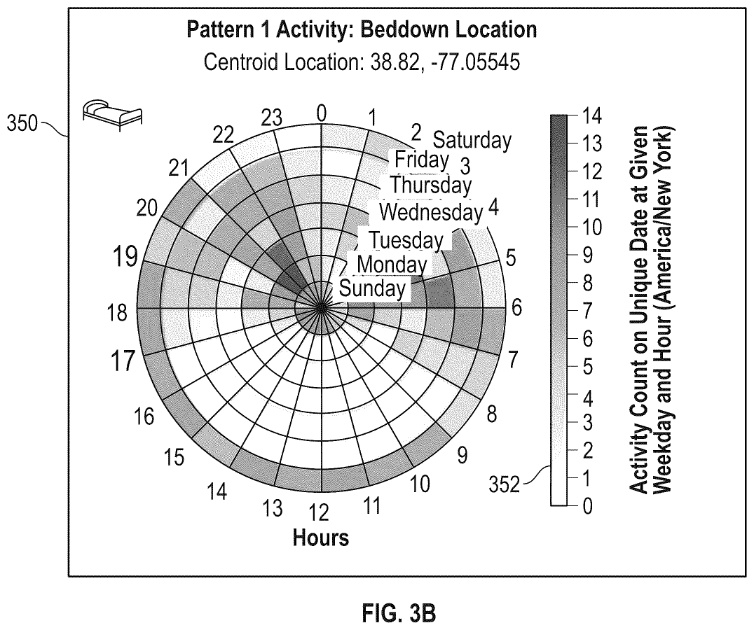

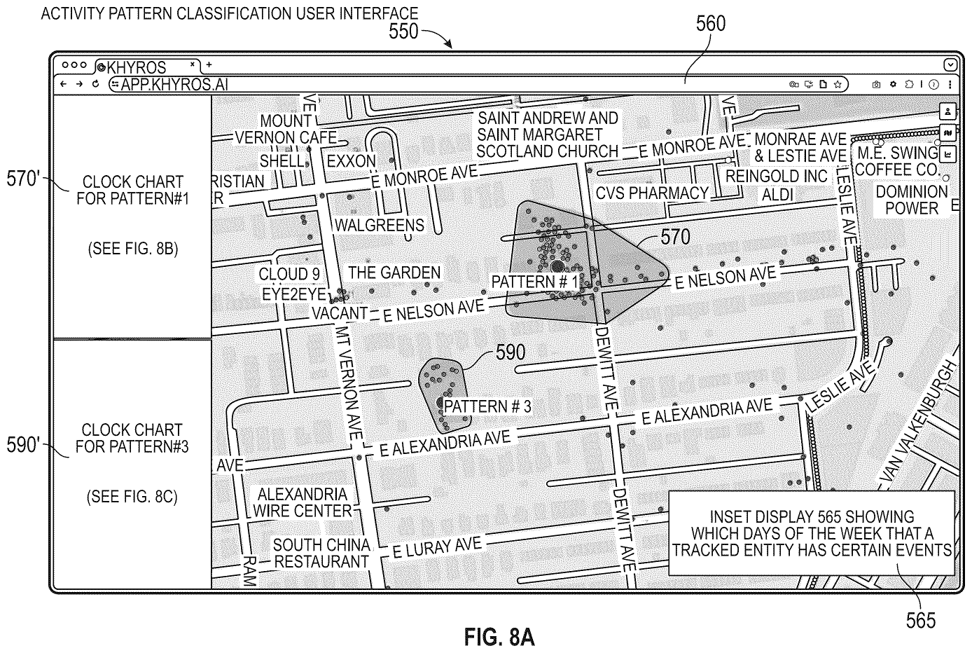

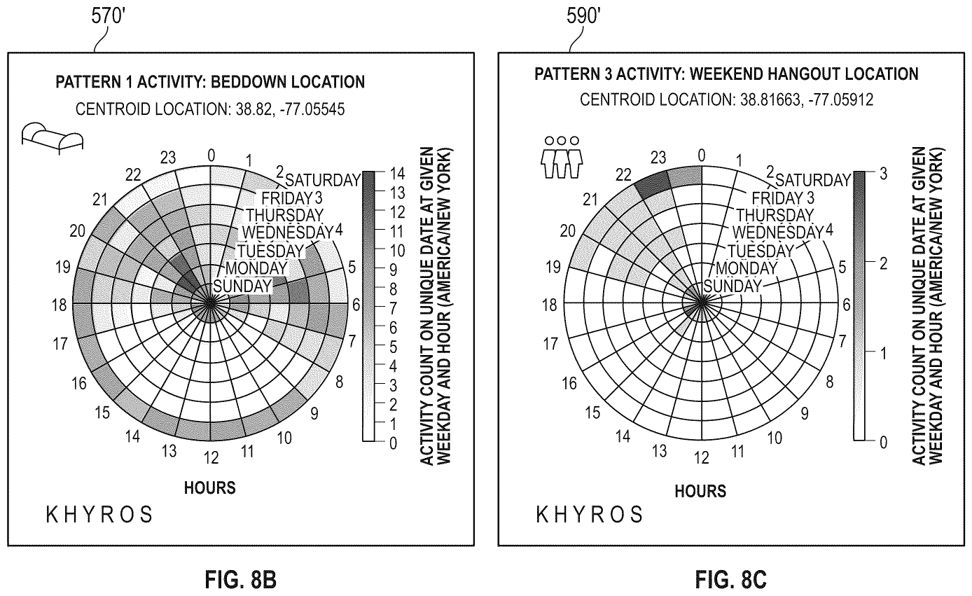

The server 110 includes an application 112 operating in conjunction with the location classification model 114 to perform the workflows described herein with regard to FIGS. 3A-7 to provide user-interface displays such as shown in FIGS. 3B, 8A-10. These operations of the application 112 can include data preparation for the geospatial data received from the client devices 130A-130N for the subsequent analysis, as shown in FIG. 2. The application 112 can also control performing the activity patterns workflow shown in FIG. 3A. In particular, the application 112 is configured to perform the steps shown in the activity patterns workflow of FIG. 3A utilizing the location classification model 114 to ultimately provide a display outputs such as shown in the user interface of FIGS. 3B, 8A-8C.

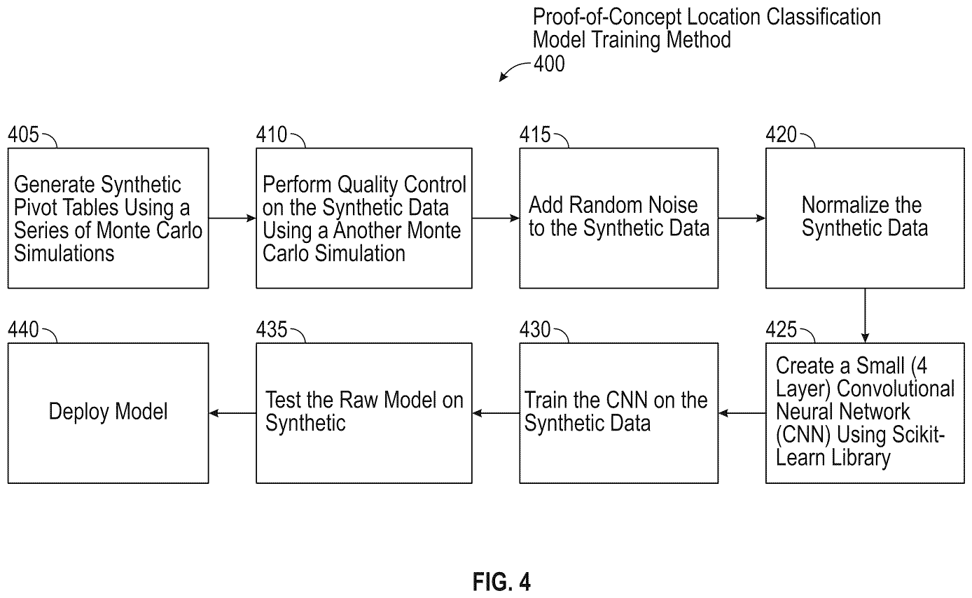

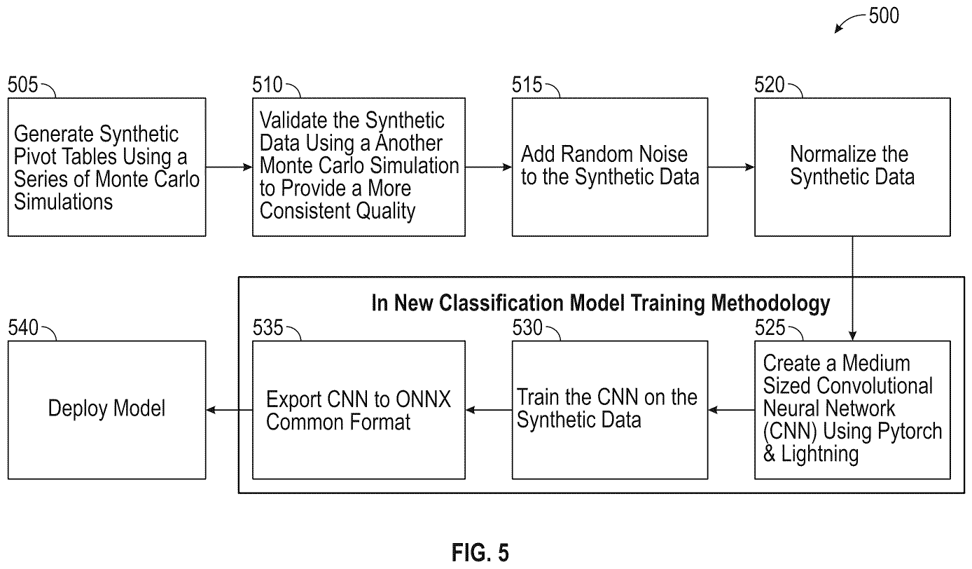

The training mechanism 116 of FIG. 1 performs training of the location classification model 114 utilizing training techniques such as those used for machine vision models in artificial intelligence systems. As shown in FIG. 4, basic proof-of concept training of the location classification model was performed by the inventors using a small convolutional neural network (CNN) using a scikit-learn library (e.g., which can be in the AI server 120 having a data store library 122). However, in accordance with the present disclosure, a more sophisticated training technique and model for the location classification model 114 is shown in FIG. 5.

The training method of FIG. 5 uses at least a larger convolutional neural network (CNN), for example a medium sized CNN, together with more sophisticated open-source machine learning frameworks, such as Pytorch and Lightning to provide for improved training methodology. For example, the use of a larger-sized network (compared to the small four-layer CNN utilized in the proof-of-concept training method of FIG. 4) allows for detecting more differences between features in the received geospatial data, thereby increasing classification accuracy. The larger CNN network also provides more tooling to refine model performance and achieve better results in terms of precision, recall, accuracy, etc. Using an open neural network technology (ONNX) framework for exporting the data for the training may increase classification speed and make the model easier to integrate across a variety of systems. Finally, the improved training techniques shown in FIG. 5 using training frameworks such as Pytorch and Lightning in combination with ONNX allows the location classification model 114 to be less susceptible to versioning and pickling issues associated with scikit-learn neural network training techniques such as those used in the proof-of-concept arrangement shown in FIG. 4.

The training mechanism 116 may use training data sets stored in the data store 122 of an AI server 120 to provide initial and ongoing training for each of the models. Alternatively, or additionally, the training mechanism 116 may use training data sets from elsewhere. In some implementations, the training mechanism 116 uses labeled training data to train one or more of the models via deep neural network(s) or other types of machine learning (ML) models. The initial training may be performed in an offline stage.

The training data may be occasionally updated, and one or more of the ML models used by the system can be revised or regenerated to reflect the updates to the training data. Over time, the training system (whether stored remotely, locally, or in a hybrid configuration) can be configured to receive and accumulate more training data items, thereby increasing the amount and variety of training data available for ML model training, resulting in increased accuracy, effectiveness, and robustness of trained ML models.

In collecting, storing, using and/or displaying any user data used in training ML models or analyzing telemetry logs, care may be taken to comply with privacy guidelines and regulations. For example, options may be provided to seek consent (e.g., opt-in) from users for collection and use of user data, to enable users to opt-out of data collection, and/or to allow users to view and/or correct collected data.

As noted above, the system 100 may include a server 120 which may be connected to or include the data store 122 which may function as a repository in which databases relating to training models, telemetry logs and/or location classification data may be stored. Although shown as a single data store, the data store 122 may be representative of multiple storage devices and data stores which may be accessible by one or more of the location classification models 114, training mechanism 116, and applications 112/134.

The client devices 130A-130N may be connected to the server 110 via a network 140. The network 140 may be a wired or wireless network(s) or a combination of wired and wireless networks that connect one or more elements of the system 100. Each of the client devices 130A-130N may be a type of personal, business or handheld computing device having or being connected to input/output elements that enable a user to interact with various applications (e.g., application 112 or application 134).

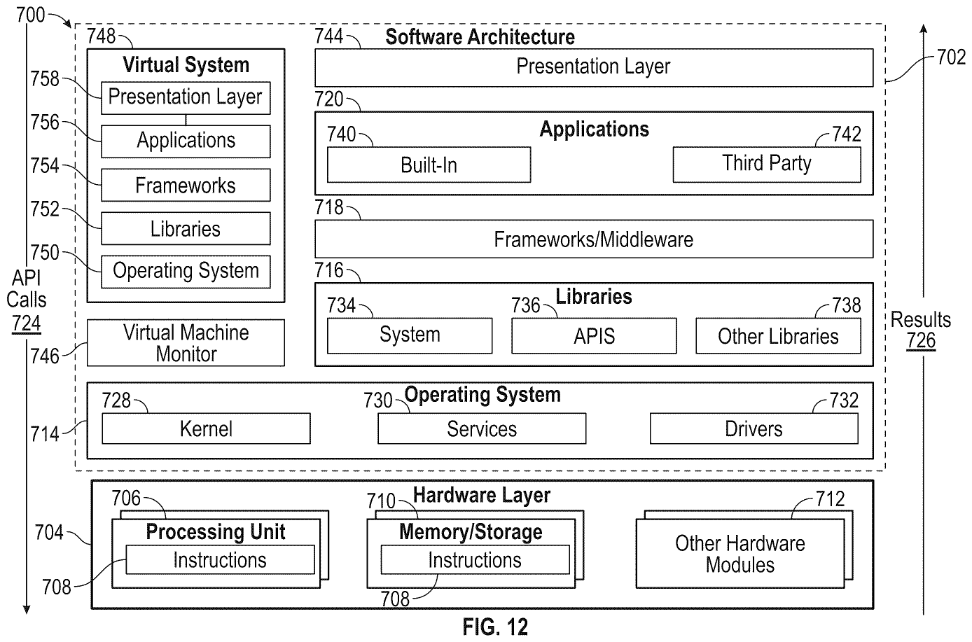

Data from user's interactions with the various applications may be collected and used by the location classification model 114 to analyze geospatial events in the manner discussed below with regard to FIGS. 3A, 6 and 7 to provide displays on a user interface (UI) such as shown in FIGS. 3B, 8A-10. One or more of the client devices 130A-130N may be utilized by one or more users to review, revise and/or approve the determined patterns and predictions provided by the location classification model 114 in the server 110. Examples of suitable client devices 130 include but are not limited to personal computers, desktop computers, laptop computers, mobile telephones, smart phones, tablets, phablets, smart watches, wearable computers, gaming devices/computers, televisions; and the like. The internal hardware structure of a client device is discussed in greater detail with respect to FIG. 12.

One or more of the client devices 130A-130N may include a local application 134. The applications 134A-134N may be software programs executed on the client device that configures the device to be responsive to user input to allow a user to perform various functions within the applications 134A-134N.

As noted above, FIG. 2 shows steps for data preparation 200 of geospatial data obtained by the client devices 130A-130N, or from other sources of geospatial data. In particular, geospatial data can be provided to the application 112 in the server 110, and the application 112 can perform the steps of data preparation shown in FIG. 2. Alternatively, the data preparation 200 shown in FIG. 2 can be performed by client devices or can be performed by an external server, prior to the prepared data being provided to the application 112 in the server 110.

The user provided geospatial data, typically provided by a user interface (UI), contains rows with geospatial data such as latitude, longitude, and timestamps. For example, this data 210 can be provided as comma-spaced-values (CSV) data. In step 215, the application 112 can prepare the data 210 for subsequent processing by first validating, cleaning and normalizing the data. Following step 215, the data can be enriched, if desired, in step 220 with additional information such as geohashes and/or temporal hashes, using known hashing techniques. After step 220, the data can be saved, for example, in step 225 in a memory in the server 112 or an external memory, for performing the analytics discussed hereinafter in FIGS. 3A, 6 and 7. It is noted that although the above description sets forth that these data preparation steps can be performed by the application 112 in the server 110, they could be performed by the applications 134A-134N in client devices 130A-130N or by an external device before providing the prepared geospatial data to the server 110. The output of the data preparation 200 is shown in FIG. 2 as “pol_finder Object” 212 which is encapsulated and prepared data to be processed by the server 110 (or prepared in the server 110) for each individual unique entity that geospatial data is provided for.

FIG. 3A is a flow diagram showing an activity patterns workflow 300, in accordance with aspects of the disclosure. As shown in FIG. 3A, the “pol_finder Object 212” (i.e., the prepared data from FIG. 2) can be provided as an input 305 to the application 112 of the server 110 for processing to determine activity patterns for the detected events and to make predictions regarding the detected events. The activity patterns workflow 300 can begin with filtering steps such as dropping data points (step 310), from the input 305 “pol_finder Object 212 data, that are indicative of an unusually high speed (e.g., faster than a typical fast walk for a user being monitored) and dropping points that have identical geo-temporal hashes (step 315) for the same entity. In other words, steps 310 and 315 provide for dropping data points in the geospatial data that are indicative of a high speed of movement of the entity above a predetermined threshold speed and dropping data points in the geospatial data that have identical geo-temporal hashes. Following this, density-based scanning can be performed on the prepared and filtered geospatial data to form data clusters (step 320). These clusters can then be attributed back to the data (step 325) and, following these steps, a pivot table 330 of unique events for unique dates and hours for each day of the week can be created for each of the clusters (step 335). An example of a simple pivot table 330 is shown in the lower part of FIG. 3A indicating the hour of the day and the number of counts for a given event, for example, on Sunday and Monday, as shown in FIG. 3A.

Still referring to FIG. 3A, after the pivot tables 330 are formed, the location classification model 114 can operate on the pivot table data in step 340 to identify likely activities for the events that have been detected at different locations based upon operations of the location classification model 114 that has been trained by the training mechanism 116. In the example shown in FIG. 3A, the timing of the events occurring in a given location based on the “pattern one” leads to the prediction by the location classification model 114 that this particular location is a “bed down location.” Similar patterns can be generated based on predictions by the location classification model 114 for work locations, hangout locations, etc. (as shown in FIG. 3B) based upon the patterns for the timing of events by the monitored entity at the location. Examples of displayed patterns for a weekend hangout location are shown, for example, in FIGS. 8A-10.

The patterns and decisions made by the location classification model 114 can be displayed on a user interface (UI) such as shown at the bottom portion of FIGS. 3B and 8. In particular, FIGS. 3B and 8A show clock charts 350 which can be derived by determining patterns in the pivot table 330 of events, taking place at various locations, and using this data to make predictions of the type of activities which occur at those locations. In particular, the clock chart 350 displays the likely activities in a color-coded manner for each day of a week such that the color-coding indicates an activity count for the likely activity for each hour of each day of the week. To this end, on the right-hand side of the clock chart 350 shown in FIG. 3B, a color gradient bar 352 is shown that correlates the activity count to particular colors. In other words, at the top of the gradient bar 352, the color red indicates the highest activity count of 14. Comparing the colors and activity counts shown on the gradient bar 352 with the coloring for individual hours indicated in the clock charts 350 allows a user to quickly identify the frequency of the likely activity through the week displayed on the clock chart 350. As noted above, in the example shown in FIG. 3B, the pattern of events at the location in question leads to the prediction by the location classification model 114 that the location is a bed-down location (in other words, the activity taking place at that location is where the person being monitored sleeps). As shown in FIGS. 3B and 8A, the clock chart 350 is color-coded based on the activity during the illustrated times for the entity being monitored, for example, based on information from a user's cell phone.

As also shown in FIGS. 3A and 3B, the output patterns and predictions from the location classification model 114 can be further enriched in step 355 with data associated with the clusters shown in the pivot table 330. This can include medoids, last scene activities, first scene activities, etc. It is also noted that although clock charts 350 are shown in the drawings, the display for given activities could take different forms, such as showing shape and duration of the activities, for example (see step 360).

As noted above, FIG. 4 shows a basic proof-of-concept location classification model training method 400 that was used by the inventors for the training mechanism 116 to train the location classification model 114. As shown in FIG. 4, this training method 400 begins with step 405 of generating synthetic pivot tables using a series of Monte Carlo simulations. Quality control can then be performed in step 410 on the synthetic data using another Monte Carlo simulation. For training purposes, random noise is added to the synthetic data in step 415, and the synthetic data is then normalized in step 420. Following normalization, the proof-of-concept training method was created in step 425 with a small (e.g. four or five layers) convolutional neural network (CNN) using, for example, a scikit-learn library (e.g., in conjunction with the AI server 120, as described above). The small CNN was then trained on the synthetic data, in step 430, and, in step 435, the raw model was tested on the synthetic data and then deployed, in step 440, to the actual model 114.

FIG. 5 shows a flow diagram 500 showing an alternative upgraded implementation of training technology of the location classification model 114 of FIG. 1, in accordance with aspects of the disclosure. As shown in FIG. 5, the initial steps for the upgraded training method for the location classification model 114 begin with the same initial steps shown in FIG. 4 of generating synthetic pivot tables using Monte Carlo simulations (step 505), validating the synthetic tables using another Monte Carlo simulation (step 510), adding random noise to the synthetic data (step 515) and normalizing synthetic data (step 520). However, the upgraded training method of FIG. 5 then deviates from the proof-of-concept techniques of FIG. 4 in that, rather than creating a small sized CNN, such as a CNN with four layers shown in FIG. 4, a larger-sized CNN is created in step 525 using more modern machine learning frameworks, for example, Pytorch and Lightning. This larger sized CNN should be at least a medium sized CNN having between 5 to 10 convolutional layers, plus pooling and fully connected layers, and thousands of parameters, ranging from a few thousand up to around one hundred thousand. A larger sized CNN (i.e., larger than a medium sized CNN could be used, if desired, but, for most applications a medium sized CNN within the above-noted number of layers and parameters is sufficient. The CNN is then trained on the synthetic data (step 530) and, in accordance with the upgraded training methodology, exported to an Open Neural Network Exchange (ONNX) common format (step 535). After these steps, the trained model is deployed (in step 540) for use in the operations described herein.

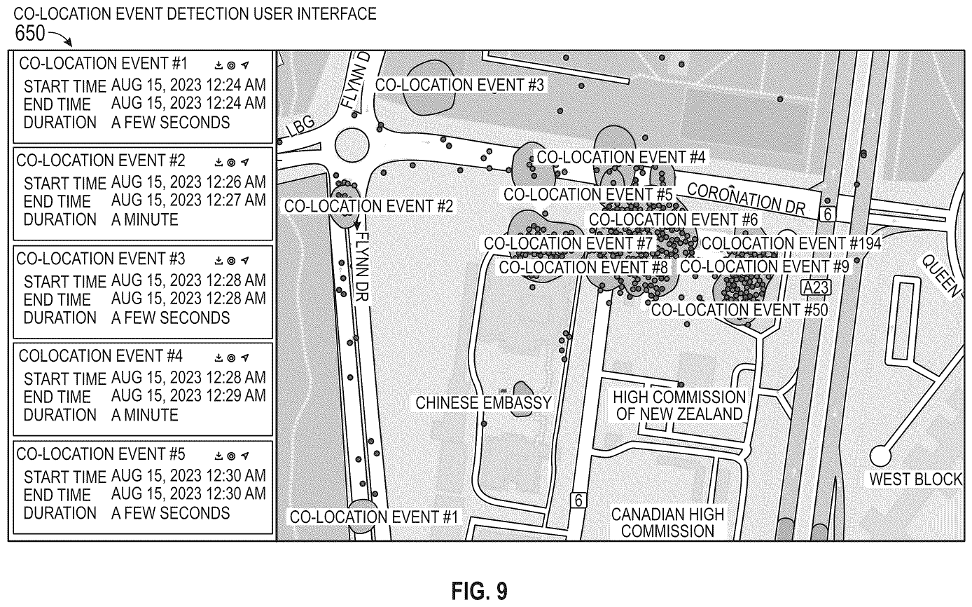

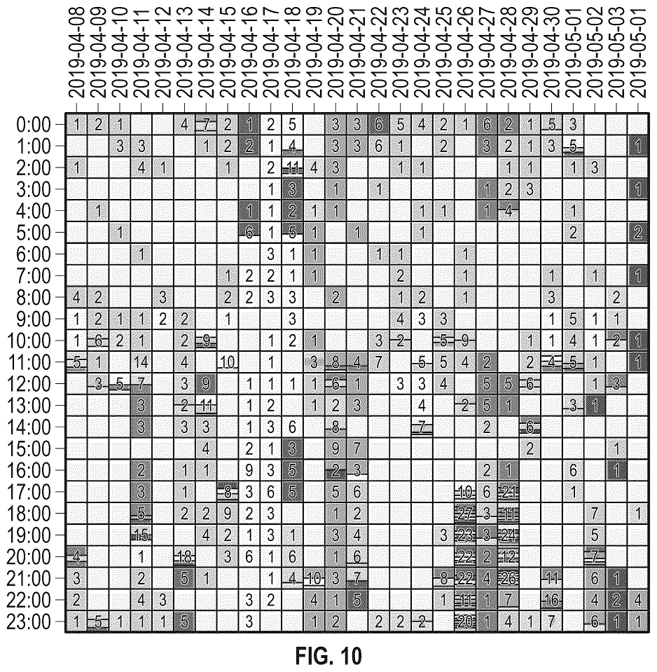

As noted above, the use of a larger-sized network (compared to the small CNN utilized in the proof-of-concept training method of FIG. 4) provides a technical solution for mapping technology in providing more accurate and detailed conversion of pivot tables to color-coded clock tables. This technical solution includes providing displays, such as shown in FIGS. 8A-10, showing estimated activities of monitored events based on geophysical data input (e.g., FIGS. 8A-8C), displays showing co-locations of entities being tracked (FIG. 9) and displays of out-of-pattern event detection (e.g., FIG. 10). As such, these technical solutions for mapping technology, using the steps of FIGS. 2, 3 and 5, including at least a medium-sized CNN and the ONNX framework have the technical advantages of allowing for detecting more differences between features in the received geospatial data, and, accordingly, providing more useful displays such as shown in FIGS. 8A-10. This results in further technical advantages of increased classification accuracy compared with using the smaller CNN of FIG. 4. The larger CNN network of FIG. 5 is a more powerful framework (compared with the small sized CNN of FIG. 4) that provides more tooling to refine model performance and achieve better results in terms of precision, recall, accuracy, etc. In addition, an ONNX framework is a technical solution for exporting the data for the training, as shown in FIG. 5 with increased classification speed. Finally, the improved training techniques shown in FIG. 5, using training frameworks such as Pytorch and Lightning, allows the location classification model 114 to be less susceptible to versioning and pickling issues associated with scikit-learn neural network training techniques (for example, SciPy).

FIG. 8A shows an example of an activity pattern classification user interface 550 that can be generated based on the improved training techniques shown in FIGS. 2, 3A and 5. The large map 560 in FIG. 8A shows locations of a person (or entity) being tracked with blue dots. It is noted that the large map 560 itself can be initially generated for an area of interest using commercially available mapping programs. The data from FIGS. 2, 3A and 5 can then be added (as shown by the blue dots) and grouped (using the steps of FIGS. 3A and 5) and added to the large map 560 as patterns. Patterns #1 and #3 are shown on the large map 560 in FIG. 8A. As shown in this large map 560 in FIG. 8A, the person being tracked moved to multiple locations over the period of time being monitored. However, as shown on the large map 560, there are concentrations of the locations of the person which are classified, using the steps shown in FIGS. 2, 3A and 5, as patterns #1 (570) and #3 (590). In the example of FIG. 8A, clock chart 570′ of pattern #1 (570) and a clock chart 590′ of pattern #3 can be shown, if desired, adjacent to the large map 560. An enlarged view of the clock chart 570′ of pattern #1 (570) is shown in FIG. 8B and an enlarged view of the clock chart 590′ of pattern #3 (590) is shown in FIG. 8C.

In FIG. 8B, the clock chart 570′ shows pattern #1 activity determined, using the steps shown in FIGS. 2, 3 and 5, to be the bed-down location for the person being monitored based upon the time frames for the tracked locations. In other words, the person being monitored is located in the area of pattern #1 activity 570 during the hours when a person would normally be sleeping. This is determined by the location classification model 114 trained with the steps shown in FIG. 5. If desired, additional information could be provided with regard to the clock chart 570′, such as address of the event, earliest activity time, latest activity time, etc.

The clock chart 590′ shows pattern #3 activity. A detailed view of the clock chart 590′ illustrating pattern #3, is shown in FIG. 8C, and is analyzed (via the location classification model 114 trained with the steps shown in FIG. 5) to be a weekend “hangout location” based upon the fact that the activities are concentrated in greater frequency over the weekends (although the person being monitored clearly frequents the pattern #3 area occasionally during the week as well). Although not shown on the map shown in FIG. 8A, another clock chart could show pattern #2 activity of a morning “hangout location” for the person being monitored, especially during weekdays. In other words, by generating maps and clock charts such as shown in FIGS. 8A-8C using the step shown in FIGS. 2, 3A and 5, using a location classification model 114, a user can quickly see activity patterns of the person (or entity) being monitored. The user can also see a breakdown of these activities into likely patterns such as patterns #1-#3 shown on the clock charts 570′ and 590′ in FIGS. 8A-8C.

In FIG. 8A, the numeral 565 is an inset display that can be generated, as an overlay of the large map 560, from datasets output from FIG. 2. This exemplary inset 565 can show which days of the week a tracked entity has certain events (e.g., the events of “Dataset 1” from the output of FIG. 2, in the example showing an FIG. 8A over a predetermined period of time). For example, the inset 565 shown in FIG. 8A, could show a one year period of time, with the horizontal axis being the fifty-two weeks of the year and the vertical axis being the seven days of each of these weeks. A similar inset can be generated as an overlay of the co-location display interface 650′ shown in FIG. 9. Of course, the time period covered by such insets can be changed, if desired, to any given time period which the user is interested in viewing.

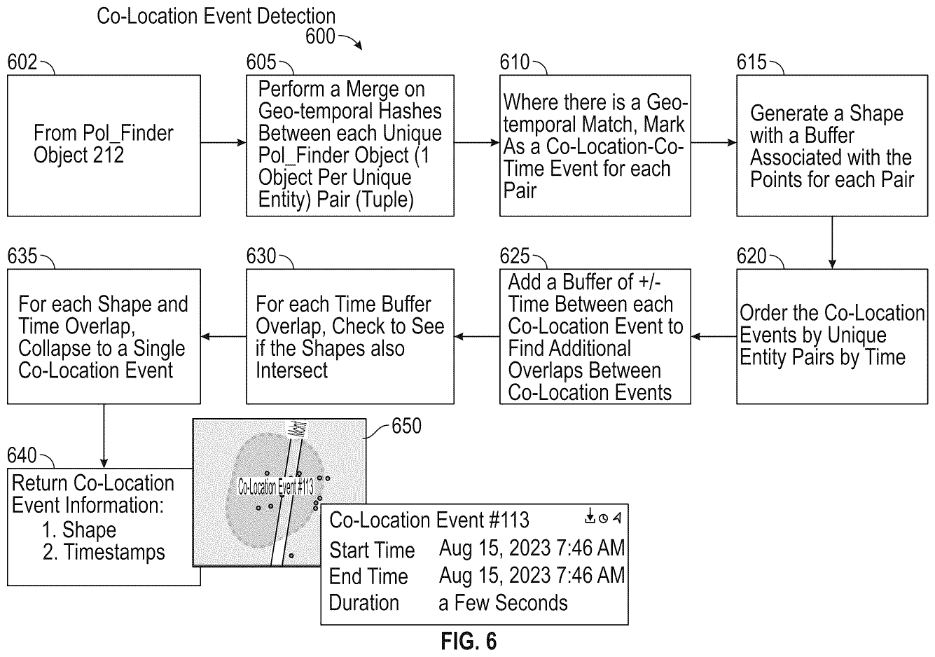

FIG. 6 is a flow diagram showing steps for co-location event detection 600, in accordance with aspects of the disclosure. FIG. 9 shows a user interface display for the co-location event detection workflow shown in FIG. 6, in accordance with aspects of the disclosure. Collocation event detection 600 permits a user to see a display, such as shown in the lower portion of FIG. 6, and in a more detailed example in FIG. 9, of co-location events of two or more entities. As an example, this co-location event detection can allow determining when two or more entities are, or were, in the same locations. Co-location/co-time event detection allows for determining when these two or more entities are in the same location at the same time (which is shown in FIG. 9), or whether they have been in the same location, but at different times.

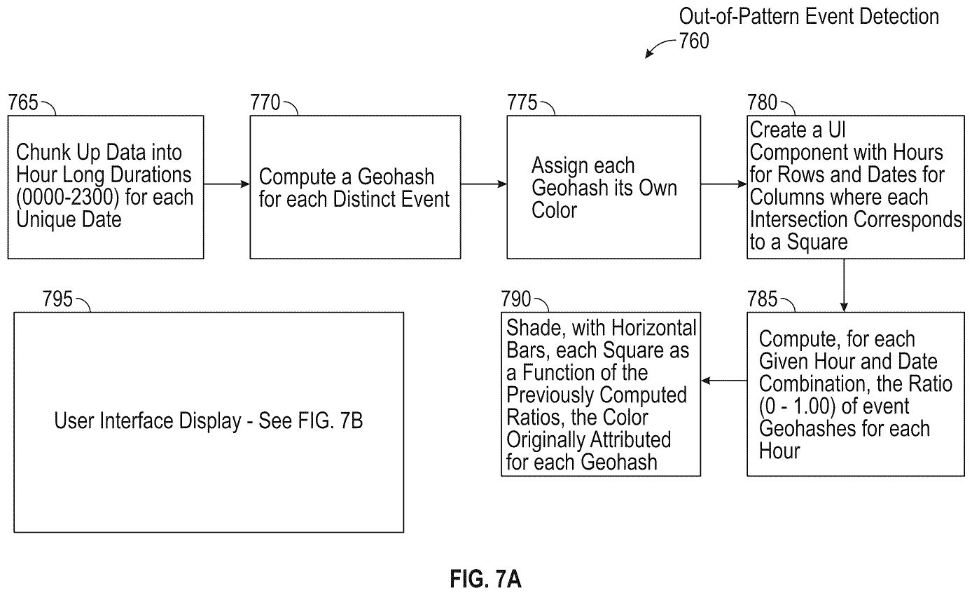

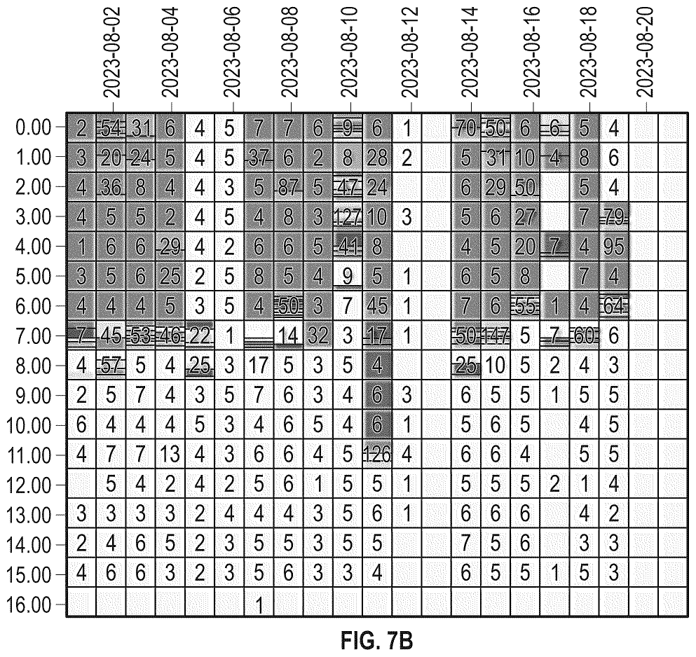

It is noted that the steps of FIG. 6 can be performed directly from the “pol_finder Object” data 212 output from FIG. 2 to determine co-location of entities being tracked, without having to go through the steps of FIG. 3A or 7A. On the other hand, the steps shown in FIG. 6 can be performed in conjunction with the system also performing the steps of FIG. 3A and/or FIG. 7A to provide a combined mapping system with the technical advantages for mapping technology of being able to provide the three significantly different displays shown in FIGS. 8A-10. In other words, using the arrangements disclosed herein, a user can determine patterns of activity for tracked entities (FIGS. 8A-8C), and/or co-location of multiple tracked entities (FIG. 9), and/or out-of-pattern event activities (FIG. 10) all from the same system utilizing the techniques shown in FIGS. 2, 3A and 5.

Referring to FIG. 6, the geospatial data for multiple entities (e.g., persons or other entities) is provided to the application 112 in the server 110, and, in step 605, a merge of geo-temporal hashes (obtained from the data preparation steps shown in FIG. 2) between each unique event pair can be performed to determine if there is a geo-temporal match between unique event pairs. Still referring to FIG. 6, in step 610, where there is a geo-temporal match, a co-location/co-time event for each pair is marked. In step 615, a shape is then generated with a buffer associated with the points for each pair (i.e., the shape is generated to encompass the points of each of the entities, together with a space around the points to ensure that the points of both entities for the co-location/co-time event for each pair are encompassed). The location events are then ordered, in step 620, for the unique entity pairs by time. For improved detection, after the ordering of the location events, in step 625 a buffer of plus/minus (+/−) time between each location event can be performed to find additional overlaps between collocation events. For each time buffer overlap, in step 630 a determination can then be made to check to see if the generated shapes also intersect. Examples of these overlaps can be seen in FIG. 9. In order to simplify the display, the technique shown in FIG. 6 can include collapsing multiple collocation events into a single collocation event (step 635). Following these steps 605-635, the returned location event information (step 640) is displayed in a user interface display 650 in terms of shapes and timestamps, as shown in FIG. 6. FIG. 9 shows a more detailed example of a co-location event detection user interface 650′ that can be generated using the steps of the co-location event detection 600 shown in FIG. 6.

Referring to the co-location event detection user interface 650′ of FIG. 9, an example is shown for determining co-locations of a first person, shown by blue dots, and a second person, shown by orange dots. The techniques discussed above with regard to FIGS. 2, 3A, 5 and 8A can be used to generate these blue and orange dots shown in FIG. 9. The steps used in FIG. 6 use the locations for these two different persons and determine co-locations.

In the lower left side of FIG. 6, a simple example of a co-location event detection user interface 650 is shown with one co-location event #113. In other words, the co-location event #113 shows a location #113 where a first person (as shown by the blue dots) is at the same location for the same time (e.g., for a few seconds) as a second person (shown by the orange dots) on Aug. 15, 2023 at 7:46 AM. Although the example shown in FIG. 6 is directed to showing collocations at the same time, the steps of FIG. 6 could be carried out to indicate whether the two persons in question were at the same location within a given time frame of one another. In other words, parameters could be set for the steps of FIG. 6 to determine whether the two persons were in the same location within one hour of each other, or one day of each other, etc.

FIG. 9 shows a more detailed co-location event detection user interface 650′ that shows numerous co-location events for two people (or entities) being tracked. It is noted that, although the examples of FIGS. 6 and 9 for the interfaces only show results for two people or entities being tracked, any number of people or entities could be monitored and displayed to show co-location events.

Referring to FIG. 9, it can be seen that the two people being tracked had numerous collocation events #1-#9 over the period of time being monitored. In particular, as shown on the left side of FIG. 9, in this particular example 329 co-location events were actually found in the data set being monitored. The first co-location event #1 occurred on Aug. 15, 2023 at 12:24 AM, and lasted a few seconds. The second co-location event #2 occurred two minutes later and lasted a minute. The right side of FIG. 9 shows a larger map indicating not only the individual locations for the first and second people being monitored (with blue and orange dots, respectively), but also the co-location events for the two people. Therefore, by viewing this detailed co-location event detection user interface 650′ using the map shown on the right side of FIG. 9 and the list of collocation events (with start times, end times, and durations), user can very quickly monitor the co-location event activities of the persons or entities being monitored.

FIG. 7A shows a flow diagram showing steps for out-of-pattern event detection 760, in accordance with aspects of the disclosure. FIG. 7B shows a user interface display 795, and FIG. 10 shows another example of a user interface display 795′ for out-of-pattern event detection, in accordance with aspects of the disclosure. In the user interface displays 795 and 795′, the horizontal axis shows individual days, and the vertical axis shows hours of each day. In other words, the user interface displays 795 and 795′ allow a user to view events of an entity being tracked every hour of every day for a predetermined period of days, with out-of-pattern events being highlighted in purple (or any other color that will stand out from the normal activities of the entity being tracked) so that a user can very easily determine the out-of-pattern events. In particular, this out-of-pattern event detection implementation 760 provides color-coding for geohashes, which color-coding allows quickly determining when the person or other entity being tracked is doing something unusual or, in some instances, when spoofing is occurring. For example, referring to the display for data in the user interface 795 at the lower left of FIG. 7A (and in detail in FIG. 7B), the color-coded purple squares can indicate either the person being tracked being in an unusual location or, alternatively, spoofing activity with regard to a particular user being tracked.

It is noted that the steps shown in FIG. 7A are preferably performed on the client side, unlike the other two workflows shown in FIGS. 5 and 6. It is also noted that, like the displays of FIGS. 8A and 9, the out-of-pattern display 795′ shown in FIG. 10 can be superimposed over a large map such, as the large map 560 shown in FIG. 8A. As such, one can be viewing the map of FIG. 8A showing where activity patterns can be found on the large map 560, and then activate the operations of FIG. 7A to generate the out-of-pattern display 795′ of FIG. 10 on top of the large map 560 of FIG. 8A.

Referring to FIG. 7A, in accordance with the implementation for out-of-pattern event detection 760, data is first chunked up (e.g., grouped) in step 765 into predetermined durations for each unique date. In the example shown in FIG. 7B, as well as the example of FIG. 10, the data can be chunked up into hour long duration for each unique date. Following this, geohashes are computed, in step 770, for each distinct event. Each geohash is then assigned its own color in step 775 to provide color-coded geohash visualizations, which, as noted above, is an important aspect and technical advantage for determining out-of-pattern detection. In other words, out-of-pattern events can be detected based on the color-coded geohash visualizations.

Specifically, as shown for dataset 3 in the user interface 795 in FIG. 7B, the majority of events have repeating similar colors. However, four squares shown with purple coloration in the user interface 795 of FIG. 7B stand out clearly as out-of-pattern events on Aug. 11, 2023 between the hours of 7:00 AM and 11:00 AM. Similar squares with purple coloration shown in the user interface 795′ of FIG. 10 show another example of such out-of-pattern events. This can indicate that the entity being monitored has moved to an unusual location. However, as noted above, it can also identify spoofing of the person or other entity being monitored. Both the ability to quickly note unusual activity, or possible spoofing are significant technical advantages of the out-of-pattern detection 760 of the present disclosure.

In order to create the types of displays shown and FIGS. 7B and 10, the next step, 770, in FIG. 7A is to create a UI component with hours for rows and dates for columns (or vice versa) with each intersection of rows and columns corresponding to a square. Once this is done, step 785 computes, for each given hour and date combination, a ratio (0-1.00) of event geohashes for each hour. Each square can then be shaded, in step 790, with a horizontal bar as a function of the previously computed ratios, with the shading being that color originally attributed for each geohash.

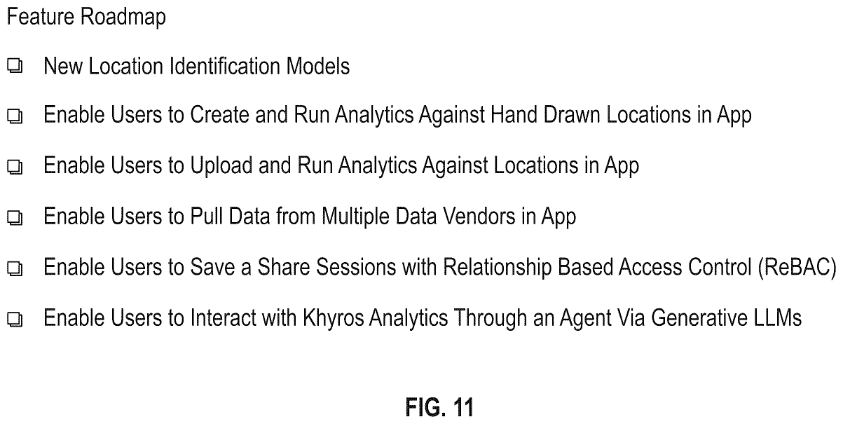

FIG. 11 shows a feature roadmap of advantageous features which can be implemented using the systems and methods disclosed in the present disclosure. This feature roadmap includes developing new location identification models, as well as enabling users to create and run analytics against hand drawn locations in the application. The feature roadmap also includes enabling users to upload and run analytics against locations in the application and enabling users to pull data from multiple data vendors in the application. Enabling users to save a shared session with relationship-based access control (ReBAC) with other users and to interact with Khyros analytics through an agent via generative LLMs are other features that can be implemented based on the present disclosure.

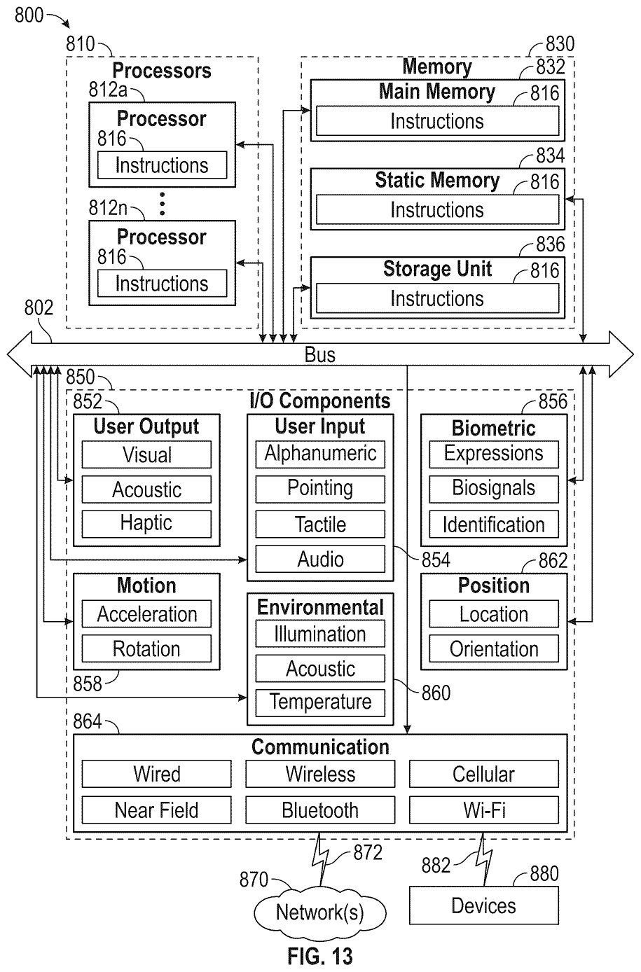

FIG. 12 is a block diagram 700 illustrating an example software architecture 702, various portions of which may be used in conjunction with various hardware architectures herein described, which may implement any of the above-described features. FIG. 12 is a non-limiting example of a software architecture, and it will be appreciated that many other architectures may be implemented to facilitate the functionality described herein. The software architecture 702 may execute on hardware such as a machine 800 of FIG. 13 that includes, among other things, processors 810, memory 830, and input/output (I/O) components 850. A representative hardware layer 704 is illustrated and can represent, for example, components of the server 110 and the client devices 130A-130N of FIG. 1. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 13, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 13 is a block diagram illustrating components of an example machine 800 configured to read instructions from a machine-readable medium (for example, a machine-readable or computer-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term ‘machine’ includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term ‘processor” includes a multi-core processor including cores that may execute instructions contemporaneously. Although FIG. 13 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 13 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system comprising:
one or more processors; and
a machine-readable media storing instructions which, when executed by the one or more processors, cause the processor to:
receive geospatial data including latitude, longitude and timestamps for a plurality of events associated with a first entity and a second entity, wherein the geospatial data has been enriched with at least one of geohashes and temporal hashes;
create a pivot table of unique events per date and hour from the received geospatial data for the first entity and the second entity;
use a location classification model on outputs of the pivot table to identify likely activities of the first entity and the second entity for the events that have been detected at different locations associated with the first entity and the second entity based upon operations of the location classification model; and
provide a display output on a user interface displaying one or more patterns of the events associated with the first entity and the second entity and the likely activities for the displayed one or more patterns,
wherein:
the display output is a clock chart displaying the likely activities in a color-coded manner for each day of a week such that the color-coding indicates an activity count for the likely activity for each hour of each day of the week; and
the location classification model is trained by a convolutional neural network (CNN) having at least five convolutional layers.

2. The system of claim 1, wherein data for training of the location classification model is exported in an open neural network exchange (ONNX) format.

3. The system of claim 2, wherein the training of the location classification model includes generating synthetic pivot tables using a series of Monte Carlo simulations, validating synthetic data of the synthetic pivot tables using another Monte Carlo simulation to provide more consistent quality to the synthetic data, adding random noise to the synthetic data and normalizing the synthetic data before creating the CNN.

4. The system of claim 1, wherein the instructions further cause the one or more processors to perform density-based scans on the received geospatial data to obtain clusters and to create the pivot table of events and a likely activity for each cluster.

5. The system of claim 4, wherein the instructions further cause the one or more processors to enrich output data from the location classification model associated with each cluster to determine medoids for the displayed one or more patterns on the user interface.

6. The system of claim 5, wherein the instructions further cause the one or more processors to drop data points in the geospatial data that are indicative of a high speed of movement of the entity above a predetermined threshold speed and to drop data points in the geospatial data that have identical geo-temporal hashes.

7. The system of claim 1, wherein the instructions cause the one or more processors to detect out-of-pattern events for the entity by:
grouping the geospatial data into predetermined time durations for each of a plurality of unique dates;
computing a geohash for each distinct event;
assigning each geohash its own color;
creating a user interface display with hours shown as one of rows or columns, and dates shown in another of rows and columns, wherein each intersection of the rows and columns corresponds to a square;
computing, for each hour and date combination of the display output, a ratio of event geohashes for each hour shown in the display output; and
shading, with horizontal bars, each square, as a function of previously computed ratios, with a color originally attributed for each geohash.

8. The system of claim 7, wherein the predetermined time durations are one hour durations.

9. The system of claim 1, wherein the instructions cause the one or more processors to detect out-of-pattern events for the entity by:
grouping the geospatial data into predetermined time durations for each of a plurality of unique dates;
computing a geohash for each distinct event;
assigning each geohash its own color to provide color-coded geohash visualizations; and
detecting out-of-pattern events based on the color-coded geohash visualizations.

10. The system of claim 1, wherein the display output includes a color gradient bar that correlates the activity count to particular colors displayed on the clock chart.

11. A method comprising:
receiving geospatial data including latitude, longitude and timestamps for a plurality of events associated with a first entity and a second entity, wherein the geospatial data has been enriched with at least one of geohashes and temporal hashes;
creating a pivot table of unique events per date and hour from the received geospatial data for the first entity and the second entity;
using a location classification model on outputs of the pivot table to identify likely activities of the first entity and the second entity for the events that have been detected at different locations associated with the first entity and the second entity based upon operations of the location classification model; and
providing a display output on a user interface displaying one or more patterns of the events associated with the first entity and the second entity and the likely activities for the displayed one or more patterns,
wherein:
the display output is a clock chart displaying the likely activities in a color-coded manner for each day of a week such that the color-coding indicates an activity count for the likely activity for each hour of each day of the week; and
the location classification model is trained by a convolutional neural network (CNN) having at least five convolutional layers.

12. The method of claim 11, wherein data for training of the location classification model is exported in an open neural network exchange (ONNX) format and the display output includes a color gradient bar that correlates the activity count to particular colors displayed on the clock chart.

13. The method of claim 12, wherein the training of the location classification model includes generating synthetic pivot tables using a series of Monte Carlo simulations, validating synthetic data of the synthetic pivot tables using another Monte Carlo simulation to provide more consistent quality to the synthetic data, adding random noise to the synthetic data and normalizing the synthetic data before creating the CNN.

14. The method of claim 11, further comprising performing density-based scans on the received geospatial data to obtain clusters and creating the pivot table of events and a likely activity for each cluster.

15. The method of claim 14, further comprising enriching output data from the location classification model associated with each cluster to determine medoids for the displayed one or more patterns on the user interface.

16. The method of claim 15, further comprising dropping data points in the geospatial data that are indicative of a high speed of movement of the entity above a predetermined threshold speed and dropping data points in the geospatial data that have identical geo-temporal hashes.

17. The method of claim 11, further comprising detecting out-of-pattern events for the entity by:
grouping the geospatial data into predetermined time durations for each of a plurality of unique dates;
computing a geohash for each distinct event;
assigning each geohash its own color;
creating a user interface display with hours shown as one of rows or columns, and dates shown in another of rows and columns, wherein each intersection of the rows and columns corresponds to a square;
computing, for each hour and date combination of the display output, a ratio of event geohashes for each hour shown in the display output; and
shading, with horizontal bars, each square, as a function of previously computed ratios, with a color originally attributed for each geohash.

18. The method of claim 17, wherein the predetermined time durations are one hour durations.

19. The method of claim 11, further comprising detecting out-of-pattern events for the entity by:
grouping the geospatial data into predetermined time durations for each of a plurality of unique dates;
computing a geohash for each distinct event;
assigning each geohash its own color to provide color-coded geohash visualizations; and
detecting out-of-pattern events based on the color-coded geohash visualizations.

20. A computer-readable storage medium for determining and displaying co-location events for different entities on a map displayed on a display device, having instructions stored thereon that, when executed by a processing system, perform a method comprising:
receiving geospatial data including latitude, longitude and timestamps for a plurality of events associated with a first entity and a second entity, wherein the geospatial data has been enriched with at least one of geohashes and temporal hashes;
creating a pivot table of unique events per date and hour from the received geospatial data for the first entity and the second entity;
using a location classification model on outputs of the pivot table to identify likely activities of the first entity and the second entity for the events that have been detected at different locations associated with the first entity and the second entity based upon operations of the location classification model; and
providing a display output on a user interface displaying one or more patterns of the events associated with the first entity and the second entity and the likely activities for the displayed one or more patterns,
wherein:
the display output is a clock chart displaying the likely activities in a color-coded manner for each day of a week such that the color-coding indicates an activity count for the likely activity for each hour of each day of the week; and
the location classification model is trained by a convolutional neural network (CNN) having at least five convolutional layers.
